(19) United States
(12) Patent Application Publication
(10) Pub. No.: US 2025/0119459 A1
(43) Pub. Date: Apr. 10, 2025

(54) AUTOMATED CYBERSECURITY MISCONFIGURATION DETECTION

(71) Applicant: Arctic Wolf Networks, Inc., Eden Prairie, MN (US)

(72) Inventors: Matthew James Aguiar, Winter Garden, FL (US); Joshua McCarthy, Morgan Hill, CA (US); David B. McKinley, Dartmouth, MA (US); Lance Rund, San Jose, CA (US)

(21) Appl. No.: 18/827,962

(22) Filed: Sep. 9, 2024

Related U.S. Application Data
(60) Provisional application No. 63/542,319, filed on Oct. 4, 2023.

(51) Int. Cl. H04L 9/40

(52) U.S. Cl. CPC H04L 63/205; H04L 63/1425; H04L 63/1433

(57) ABSTRACT

A computer-implemented method for cybersecurity management is disclosed. One or more cybersecurity threat protection applications deployed across a managed network are accessed. The cybersecurity threat protection applications are managed using a security orchestration, automation, and response (SOAR) platform. One or more threat protection indications from the cybersecurity threat protection applications are accumulated and analyzed. The analyzing determines an indication abnormality, inferring a cybersecurity threat protection application misconfiguration. The misconfiguration can be based on false positive indications, conflicting indications from two or more cybersecurity threat protection applications, or time-sequenced indications from one or more cybersecurity threat protection applications. The analyzing and inferring are performed using machine learning which is embedded in the SOAR platform. Remedial actions based on the inferred misconfiguration are provided to personnel staffing a security operations center and/or ingested by the SOAR for automatic reconfiguration.

### INCORPORATION BY REFERENCE

This application claims the benefit of priority of U.S. Provisional Application No. 63/542,319, filed Oct. 4, 2023, the entire contents of which are incorporated herein by reference.

### FIELD OF ART

This application relates generally to cybersecurity management and more particularly to automated cybersecurity misconfiguration detection.

### BACKGROUND

Computer security has been a concern since the first computers were created. At first, security was primarily a matter of managing physical access to the computer mechanisms themselves. Computer systems were large, sometimes filling entire rooms. They needed specialized power and environmentally controlled spaces. Programming and operating a computer required direct physical access. Computers could only execute one program at a time and required specialists to create a program, feed the program into the computer, execute the program, and receive the run results. The ability to use the computer was limited to those with specialized knowledge of the systems, mathematics, or often both. Someone wanting to do harm to the computer itself or use the computer for illegitimate or illegal purposes required physical access, the ability to program, and the appropriate knowledge to operate the computer. Security, therefore, was focused on maintaining the computer components and the environment required to run them, and controlling access to the computer system itself.

As computer system capabilities expanded, the ability to run programs more quickly and easily also grew. Programs could be input using punch cards, punch tapes, and magnetic tapes which could be fed into the computers faster and more accurately. Data could be recorded on magnetic media and recalled as needed. Advances in computing power, memory, and storage allowed the time required to execute a program to be shorter than the time required to prepare the program to run. This led to the development of time sharing and multiple user access points. Computer operating systems, memory, and storage management evolved to the point where multiple groups of users could work on a computer at the same time. The computer cycled from one user to the next in turn, executing their programs, storage requests, and so on. Computer users could type in commands and programs using electronic keyboards, punch tape, or card readers. CRT (cathode-ray tube) displays eventually replaced reams of paper, allowing the users to see what they typed as well as to read the responses from the computer system. Computer security became somewhat more complicated as user access points or terminals were spread out across buildings. At this point, however, physical wire was still necessary to access the computer or to receive output from it. Security was still centered on protecting the computer system components and the physical environment, and controlling access to the user workstations. Operating systems added usernames and passwords to ensure that those using the computer were authorized to do so. As the number of computer users increased, and the amount of specialized knowledge required to interact with computer systems decreased, more attention was paid to ensuring that the computer users were performing their duties correctly and appropriately.

With the coming of the Internet, personal computers, mobile phones, and wireless networks, the need for computer security has multiplied. Users with no background in computer science or even a basic understanding of computer systems can now access vast amounts of data and processing power. Cellphones, tablets, pads, and home game platforms can now be used to access multiple computers simultaneously, in many cases represented by a simple web server platform. Advances in communications and networking have created a situation in which users from across the globe can access systems anonymously or nearly so. As computing power and access has grown, cybercrime has also increased. Financial systems can be burgled or jumbled; individual users, families, and small business can be robbed or exploited; infrastructure systems can be destroyed; and public and private information can be stolen. As the number and types of malicious and accidental security breaches have grown, our collective need for cybersecurity has multiplied many times over. Our continued reliance on computer systems of all types means that businesses, governments, and individual users will require computer security systems and strategies for many years to come.

### SUMMARY

Modern-day businesses, governments, and individuals are increasingly dependent on computer systems. Indeed, successful organizational operations are closely linked to an effective IT and computing infrastructure. Reliable computer operations are enabled by effective detection, diagnosis, management, and mitigation of cybersecurity threats of all types. All organizations and many individuals are impacted by cybersecurity threats. The organizations include businesses, financial institutions, hospitals, government agencies, retailers, universities, and schools, among many others. These groups are painfully aware of the broad spectrum of cybersecurity threats that are directed toward them. Those that are not aware of these threats can receive an education by fire within days, if not hours, of opening their doors. IT groups within the organizations actively configure, implement, and deploy state-of-the art cybersecurity hardware and software with the objective of securing their IT infrastructure against the threats. While routine, preventative measures, such as installing updates to applications and operating systems software, deactivating accounts of former users, security (“white hat”) checkups, and other housekeeping activities are common to successful IT operations, these measures alone are inadequate to provide comprehensive IT infrastructure protection. The cybersecurity threats evolve rapidly and continue to become significantly more sophisticated. Thus, constant system-wide vigilance and anticipatory action are demanded. With so many threats and strategies to counter the threats being promulgated, maintaining an array of security applications and management processes can be daunting. Improper or outdated configurations of applications can lead to increased vulnerability or security breaches before IT teams can effectively protect their networks. Thus, securing a network requires diligence by security experts and their technologies.

A computer-implemented method for cybersecurity management is disclosed comprising: accessing a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform; accumulating one or more cybersecurity threat protection indications from the plurality of cybersecurity threat protection applications; analyzing the one or more cybersecurity threat protection indications that were accumulated, wherein the analyzing determines an indication abnormality; and inferring a cybersecurity threat protection application misconfiguration, based on the analyzing.

In other embodiments, a computer program product is included in a non-transitory computer readable medium for optimization, the computer program product comprising code which causes one or more processors to perform operations of: accessing a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform; accumulating one or more cybersecurity threat protection indications from the plurality of cybersecurity threat protection applications; analyzing the one or more cybersecurity threat protection indications that were accumulated, wherein the analyzing determines an indication abnormality; and inferring a cybersecurity threat protection application misconfiguration, based on the analyzing.

In some implementations, the embodiments described herein can include one or more of the following features. For example, the misconfiguration can indicate a cybersecurity threat protection application false positive. The false positive can be determined by non-permitted application scenarios. The false positive can be determined by security operations center personnel. The false positive determined by security operations center personnel can occur two or more times. The two or more times can occur within a defined time window. The cybersecurity threat protection application misconfiguration can cause the cybersecurity threat protection indication. The analyzing can include feedback from SOAR personnel.

As another example, the indication abnormality can be based on one or more cybersecurity threat protection indications from a single type of cybersecurity threat protection application. The single type of cybersecurity threat protection application can include one or more antivirus-class applications. The indication abnormality can be based on a time-sequenced commonality among two or more cybersecurity threat protection indications. The time-sequenced commonality can occur over more than one day. The time-sequenced commonality can occur over more than one login of an endpoint application. The indication abnormality can be based on two or more cybersecurity threat protection indications from a group of cybersecurity threat protection applications. The indication can be based on a time-sequenced commonality among the group of cybersecurity threat protection applications. The time-sequenced commonality can occur over more than one day. The time-sequenced commonality can occur over more than one login of an endpoint application. The indication abnormality can include a positive threat protection indication from one cybersecurity threat protection application and a contemporaneous negative threat protection indication from another cybersecurity threat protection application.

In some implementations, the method can also include providing a remedial action, based on the inferring. The remedial action can be provided to personnel staffing a security operations center. The method can also include reconfiguring one or more cybersecurity threat protection applications, based on the remedial action that was presented. The providing a remedial action and/or the reconfiguring can be determined by the personnel staffing a security operations center. The remedial action can be ingested by the SOAR for automatic reconfiguration. The method can include reconfiguring one or more cybersecurity threat protection applications, based on the remedial action that was presented. The providing a remedial action and/or the reconfiguring can be determined using machine learning. The analyzing and/or the inferring can be performed using machine learning (ML). The ML can be embedded in the SOAR platform. The ML can be trained by data gathered by one or more instantiations of the SOAR platform. The ML can be accessed through an application program interface in the SOAR platform.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for automated cybersecurity misconfiguration detection.

FIG. 2 is a flow diagram for threat indication commonality handling.

FIG. 3 is a block diagram for cybersecurity mitigation management.

FIG. 4 is a system block diagram for automated cybersecurity misconfiguration management.

FIG. 5 shows a network-connected security orchestration, automation, and response (SOAR) system.

FIG. 6 illustrates an example neural network for machine learning.

FIG. 7 shows an example of training a neural network for machine learning.

FIG. 8 is an infographic for cybersecurity misconfiguration detection.

FIG. 9 is a system diagram for automated cybersecurity misconfiguration detection.

### DETAILED DESCRIPTION

Computer systems and the networks in which they operate are the targets of constant security attacks. They are the targets of hackers, spammers, confidence tricksters, and all manner of criminals who are hiding onshore, offshore, or even within the enterprises themselves. Such malefactors include individual criminals, gangs, and organized crime rings; expert hackers sponsored and protected by enemy and rogue governments; and terrorists and extortionists; among many others with malicious intent. Their attacks are directed at businesses, government agencies, hospitals, research laboratories, retailers, universities, and other enterprises and organizations. Data from firewalls and other public facing network devices show that threats such as cyberattacks, phishing expeditions, and attempted data theft or destruction occur as often as every few seconds. By far the most frequently targeted enterprises include those from sectors such as high technology, retail, and government agencies including defense, air traffic control, and revenue. Other high-value targets include media companies who are called out by cyberattackers for allegedly insulting a religion or humiliating national leaders. Further, national infrastructures such as pipelines and energy grids are targets because of the disruption caused by their being disabled or interrupted.

Effective cybersecurity requires highly complicated suites of tools and activities. The challenge is to execute the integration correctly and to maintain the setup and interactions of the various components as security threats expand and change. Proper cybersecurity implementation and configuration is extremely complex and expensive. The tasks associated with cybersecurity are constantly in flux. Cybersecurity measures undertaken today by the enterprises can detect and prevent known or recently discovered attack techniques. However, the techniques and ploys used by cybercriminals are constantly evolving, specifically to thwart or circumvent the cybersecurity measures. Nearly as soon as a cybersecurity threat tool is developed for identifying, reacting to, and eradicating a cybersecurity threat such as a virus, a Trojan horse program, a phishing scheme, or a denial-of-service attack, the cybercriminals adapt their cyberthreat techniques. The cyberthreats often target newly discovered flaws and vulnerabilities in hardware and software. This latter class of cyberthreat is often referred to as a “zero-day” attack since the victims of the attack have had zero days to identify and counter the attack. Integrating changes to multiple security applications to counter new threats can easily lead to misconfigurations of existing hardware or software components. What worked yesterday may not work today as the security arsenal shifts to meet current requirements. Detecting incorrect application configurations and addressing them quickly is a challenge for IT security specialists that will continue well into the future.

Techniques for cybersecurity management are disclosed. A plurality of cybersecurity threat protection applications deployed across a managed network can be accessed and managed using a security orchestration, automation, and response (SOAR) platform. As cybersecurity incidents occur, threat indications from the various threat protection applications are accumulated and amalgamated by the SOAR platform. The threat indications are fed into an artificial intelligence (AI) machine learning model and compared to patterns of threat indications generated by previous threat events. Patterns that are recognized are mitigated using workflows and commands sent to the various cybersecurity threat protection applications, in cooperation with security operations center (SOC) personnel. The SOC staff can monitor, modify, or replace mitigation steps generated by the SOAR platform in real time. As threats are mitigated, the machine learning model records and analyzes the steps taken, learns from the results, and works to improve responses to the next security threat. When a pattern of threat indications is not recognized by the machine learning model, a security application misconfiguration can be inferred. The SOAR platform can generate steps to mitigate one or more threat protection applications in order to address the issues raised by the misconfiguration. The SOC personnel can review the mitigation steps generated by the machine learning model prior to their installation, or in some cases, the SOAR platform can apply the configuration changes to the cybersecurity applications directly. The result is a faster response to misconfigurations of vital security applications and stronger maintenance of network and application operations.

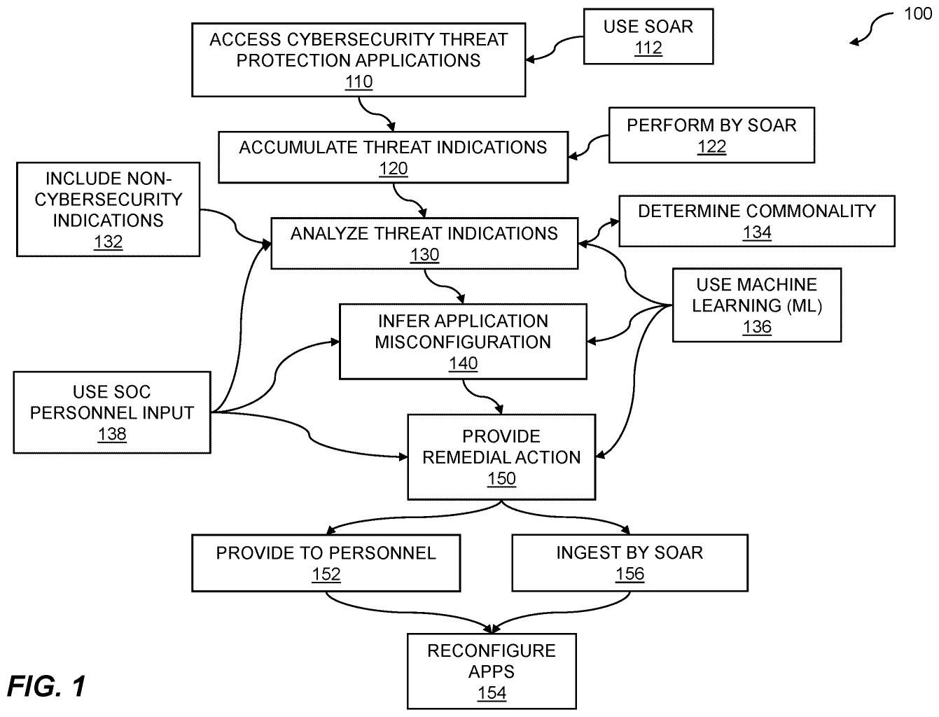

FIG. 1 is a flow diagram 100 for automated cybersecurity misconfiguration detection. The flow 100 includes accessing 110 a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform 112. The threat protection applications can monitor, protect, and defend computer systems, data systems, data networks, handheld electronic devices, and so on against various types of malicious attacks. The malicious attacks can include malware attacks, hacking attacks, denial of service attacks (DoS), distributed denial of service attacks (DDoS), man-in-the-middle attacks, ransomware attacks, and so on. The applications can include antivirus and anti-phishing applications, tools for threat hunting and threat intelligence, identity verification, endpoint protection, and so on. The applications can further include firewalls and other blocking technology.

The SOAR platform 112 enables the management and maintenance of the cybersecurity threat protection applications, coordinates the coverage of the applications across the network, and handles the analysis and mitigation of cybersecurity events as they occur. The SOAR platform can enable data collection from a wide range of data sources, such as threat data sources, using an artificial intelligence (AI) user interface. The threat data sources can include data uploaded by cybersecurity experts, data produced by cybersecurity threat protection applications, and so on. The SOAR platform can be used to manage threat protection processes, anti-threat technologies, and human expertise. The SOAR platform can centralize management of IT assets such as networks, processors, data storage elements, etc. The SOAR platform can provide threat alerts and can also provide contexts for the alerts. The SOAR platform can further automate responses to threats, adapt the responses using machine learning, and so on.

The flow 100 includes accumulating 120 one or more cybersecurity threat protection indications from the plurality of cybersecurity threat protection applications. The inputs can include alarms, alerts, notifications, status changes and updates, warnings, etc. The plurality of inputs can include threat notifications. The inputs can be in reference to virus detection, Trojan horse detection, insider threat detection, cryptojacking detection, intrusion detection, and so on. The inputs that are received can include one or more signals, flags, SMS or email messages, indications, and other outputs generated by the plurality of applications. In embodiments, the accumulating indications from the plurality of cybersecurity threat protection applications is performed by the SOAR platform 122. The SOAR platform can accumulate the threat indications, sort, and categorize them, send acknowledgments to the relevant threat protection applications, and organize the indications data input for analysis.

The flow 100 includes analyzing 130 the one or more cybersecurity threat protection indications that were accumulated, wherein the analyzing determines an indication abnormality. In embodiments, the analyzing 130, the inferring 140, and/or the providing 150 are performed using machine learning (ML) 136. The ML can be embedded in the SOAR platform. A machine learning (ML) model can be built using data from the cybersecurity threat protection applications through one or more APIs. Previous cybersecurity events occurring on the network and captured by the SOAR platform can be used as training data. Multiple instantiations of the SOAR platform can be generated to test and refine actions and responses to various cybersecurity threats, application update requirements, actions taken by users and/or operations security staff members, and so on. As cybersecurity events occur, either within the SOAR-managed cybersecurity network or on similar networks across the globe, incident reports in various forms are published by threat protection application vendors, regulatory agencies, auditors, watchdog agencies, internal audit and compliance departments, IT departments, and so on. All of this input can be used to update and refine cybersecurity workflows, policies, rules, and application settings.

In embodiments, the analyzing 130 can determine time-sequenced commonality 134 between threat indications generated by one or more threat protection applications. The time-sequenced commonalities can occur over more than one day, or over more than one login of an endpoint application. The analyzing can also include feedback from security operations center (SOC) personnel 138. The SOC personnel can use the SOAR platform to review and respond to cybersecurity threat indications as they are accumulated and analyzed. In some embodiments, the analyzing includes non-cybersecurity indications 132. The non-cybersecurity indications can include human resource (HR) factors such as cybersecurity user proclivities and cybersecurity user demographics.

In embodiments, the machine learning model is trained to recognize patterns of cybersecurity threat protection application data that are generated by cybersecurity threats, security operations procedures, SOC tests, practice runs, cybersecurity threat data from third-party sources, regulatory agencies, cybersecurity advisory groups, previous cybersecurity responses, and so on. As new cybersecurity events occur, the threat indications flow into the SOAR platform and are fed into the machine learning model. The ML model analyzes the threat indication data and compares it to previous cybersecurity events. When the threat indication data is recognized based on previous similar events, the SOAR platform can respond by generating workflows, instructions to threat protection applications, notifications to SOC personnel, and so on. When threat indication data does not fit previously recorded patterns and is outside of established variation levels, the SOAR platform can infer cybersecurity threat protection application misconfiguration and take additional steps. In such a situation, it is possible that a real cybersecurity threat which the SOAR platform has not previously encountered is taking place, and that the threat indications being accumulated by the SOAR platform represent a clear and present danger to the network. The SOC personnel can review the cybersecurity threat protection application misconfiguration analysis and inferences generated by the SOAR, along with the suggested remedial action steps, and decide how to proceed.

The flow 100 includes inferring 140 a cybersecurity threat protection application misconfiguration, based on the analyzing. In embodiments, a cybersecurity threat protection application misconfiguration causes the cybersecurity threat protection indication. The misconfiguration can indicate a cybersecurity threat protection application false positive. The indication abnormality can be based on one or more cybersecurity threat protection indications from a single type of cybersecurity threat protection application. The indication abnormality can be based on two or more cybersecurity threat protection indications from a plurality of cybersecurity threat protection applications. The inferring 140 can also include feedback from security operations center (SOC) personnel 138. Feedback from an SOC personnel review of the inferred misconfiguration can be included in the ML model, which can increase the accuracy and effectiveness of the inferred misconfiguration.

The flow 100 further comprises providing 150 a remedial action, based on the inferring. In embodiments, the remedial action is provided to personnel 152 staffing a security operations center. The remedial action can include reconfiguring 154 one or more cybersecurity threat protection applications. The providing a remedial action and/or the reconfiguring are determined by the personnel staffing a security operations center. In other embodiments, the remedial action is ingested 156 by the SOAR for automatic reconfiguration. The remedial action can include reconfiguring one or more cybersecurity threat protection applications. The providing a remedial action and/or the reconfiguring are determined using machine learning. The providing 150 can also include feedback from security operations center (SOC) personnel 138. Feedback from an SOC personnel review of the provided remedial action can be included in the ML model, which can increase the accuracy and effectiveness of any remedial action steps that are provided.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow, or portions thereof, 100 can be included on a semiconductor chip and implemented in special purpose logic, programmable logic, and so on.

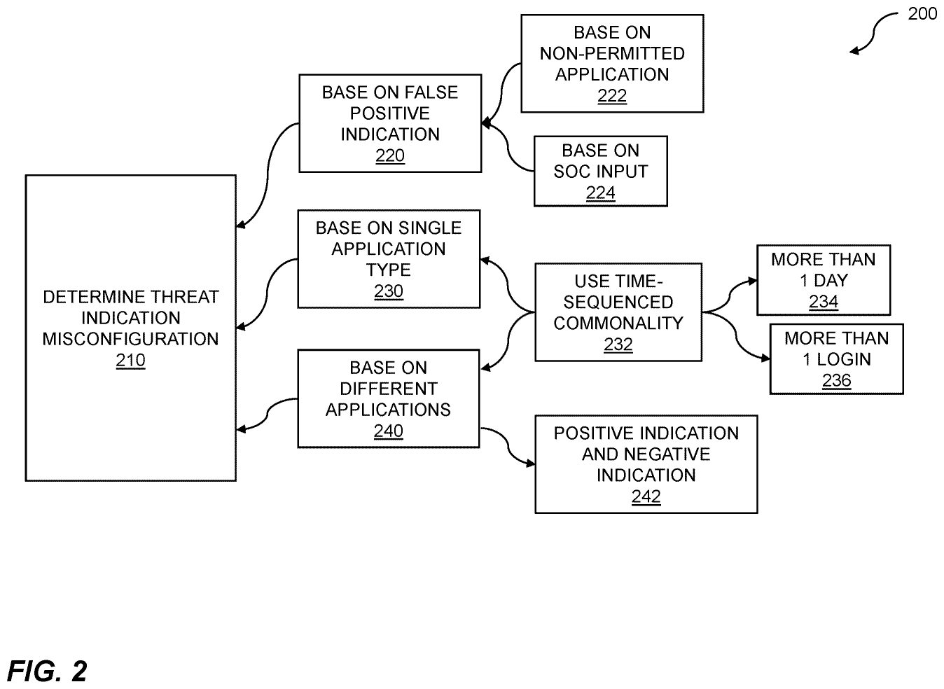

FIG. 2 is a flow diagram 200 for threat indication commonality handling. The flow 200 includes determining 210 a cybersecurity threat protection application misconfiguration, based on the analyzing done by the SOAR platform. In embodiments, the determining of a cybersecurity threat protection application misconfiguration can be based on a false positive indication 220. A false positive is an alert or vulnerability notification from a threat protection application that is incorrectly flagged, indicating a danger or vulnerability that does not actually exist. A false positive can be caused by making a threat protection application setting too sensitive, setting a time window for an application too narrow, etc. For example, a virus scan can be scheduled to run on a workstation or server that normally receives a set of work files thirty minutes before the virus scan begins. On certain days, the work files tend to be larger than average, causing the file transfer time to take much longer. If the virus scan begins before the file transfers are complete, some files may not be able to be scanned, causing an alert to be generated by the virus scan application. In this example, there is no actual security threat from the work files that cannot be scanned, even though an alert from the virus scan application has been generated. The virus scan schedule has been misconfigured and can be changed by the SOC team after reviewing the threat indication misconfiguration analysis.

In some embodiments, the false positive can be determined based on non-permitted application scenarios 222. For example, a department schedules a set of reports which can be scheduled to run overnight while a required database is being backed up, or an application can be set to update stock prices from a different website than the site normally used. These situations can generate alerts that can be identified by the machine learning model included in the SOAR platform. Rather than being flagged as cybersecurity threats, the SOAR platform can notify SOC personnel to address the alerts by working with the departments or applications involved, or in some embodiments, the SOAR platform can remediate the problems directly.

In some embodiments, the false positive can be determined based on actions taken by security operations center personnel 224. The false positive can be caused by an action taken by a SOC staff person several times within a specific time period. For example, a SOC staff person receives a call to unlock a user account several times on the same day or unlock a service account at the same time every week. The SOC person can work with a user to set up a new password or research the service account problem that locks the account based on alert information received by the SOAR platform.

The flow 200 includes the indication abnormality based on one or more cybersecurity threat protection indications from a single type 230 of cybersecurity threat protection application. In embodiments, the single type of cybersecurity threat protection application can include one or more antivirus-class applications. For example, in a zero-day threat scenario in which a new virus threat is only discovered as it is spreading, updates can be released by several virus scanning vendors within a few hours. Notifications from the virus scanning vendor websites or host servers can be received by the SOAR platform in rapid succession and can be forwarded to the SOC staff for decisions as to how and when to reconfigure the antivirus applications within the network. In other embodiments, the indication abnormality can be based on a time-sequenced commonality 232 among two or more cybersecurity threat protection indications. The time-sequenced commonality can occur over more than one day 234 or can occur over more than one login 236 of an endpoint application. For example, a vendor website which hosts one or more databases accessed by multiple servers protected by the SOAR platform can make a change to one of its public-facing routers or IP addresses. As various servers protected by the SOAR platform attempt to access the external databases, alerts can be generated and received by the SOAR platform. Since not every internal server attempts to access the external databases on the same day or at the same time, multiple alerts which are all similar in nature can be generated by the same internal servers or applications for several hours or days.

The flow 200 includes an indication abnormality based on two or more cybersecurity threat protection indications from a plurality of cybersecurity threat protection applications 240. In embodiments, changes to critical hardware, operating systems, operations applications, databases, etc. can generate multiple alerts and flags from many different cybersecurity and business applications at the same time. For example, a change to a service account password for a database server used by multiple applications and departments can generate scores of access alerts within a few minutes, depending on the time of day. A change to a firewall that governs access to external websites and servers can easily lead to hundreds of access and application alerts in seconds in a large network. In other embodiments, the indication abnormality can include a positive threat protection indication from one cybersecurity threat protection application and a contemporaneous negative threat protection indication from another cybersecurity threat protection application 242. For example, an email containing a link to a new phishing webpage can be scanned by an antivirus application or endpoint security application and generate negative threat assessments while an anti-phishing application can scan the same email and generate a positive threat indication. After the disparate assessments are flagged and reported by the SOAR platform, the SOC can choose to reconfigure the endpoint security and antivirus applications to flag subsequent emails with the same phishing link as threats.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow, or portions thereof, 200 can be included on a semiconductor chip and implemented in special purpose logic, programmable logic, and so on.

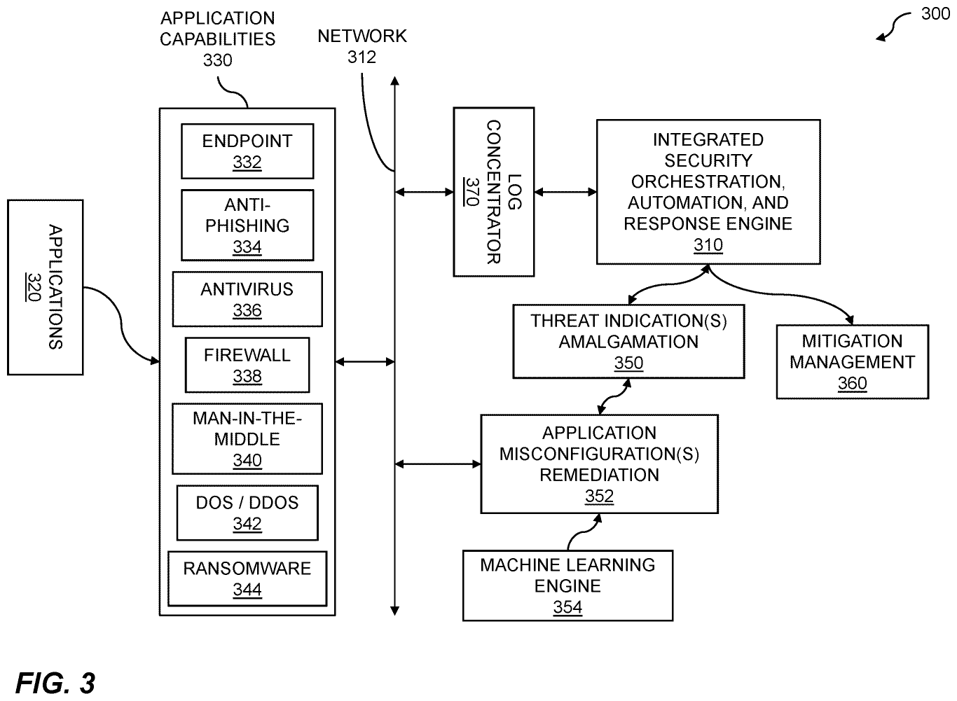

FIG. 3 is a system block diagram 300 for cybersecurity mitigation management. An example system block diagram 300 for threat management is shown. Threat management such as cybersecurity threat management is critical to an organization. The cybersecurity threat management is used to monitor operations such as data operations within the organization. When anomalies or outright threats are detected, threat management applies a variety of techniques to determine the cause of an anomaly, a source of a threat, and responses to the anomalies and threats. The block diagram 300 can include an integrated cybersecurity threat management and response engine 310. The management and response engine can access applications; collect and ingest log files from the applications; sort, integrate, and evaluate threat protection elements; and so on. The engine can include one or more processors; processor cores within integrated circuits or chips, CPUs, and GPUs; and so on. The management and response engine can be coupled to a network 312 such as a computer or cybersecurity network. The network can be based on wired and wireless communications techniques.

The block diagram 300 can include a plurality of applications 320. The applications can include network-connected cybersecurity threat protection applications. The applications can perform tasks such as network and processor monitoring; data integrity monitoring; data, services, and physical access control; etc. Some applications within the plurality of threat protection applications can perform unique tasks, similar or redundant tasks, and the like. The applications within the plurality of cybersecurity threat protection applications can include application capabilities 330. The application capabilities can include endpoint protection 332. Endpoint protection can include authentication and supervision of “endpoint” devices. The endpoint devices can include desktop computers, laptop computers, tablet computers, personal electronic devices such as smartphones and PDAs, and so on. Endpoint protection can include enabling access of the endpoint devices based on one or more rights. Access rights can include creating, editing, and deleting files, folders, and so on. Access rights can include read-write, read-only, write-only (e.g., a drop box), etc. Endpoint protection can restrict access, impose security rules, and the like.

Application capabilities can include anti-phishing 334 techniques. “Phishing” threats can be based on sending fraudulent email messages, where the messages appear to be from a legitimate sender who may be known to the recipient. The messages are used to gather sensitive, identifying information about an individual which is then used to defraud the individual. The application capabilities can include antivirus 336 techniques. Antivirus techniques can be used to detect viruses that can be embedded in data such as images, audio files, and so on. The application capabilities can include firewall 338 techniques. Firewall techniques can be used to block network traffic, applications, etc. that can attempt to penetrate a network and IT infrastructure using one or more network ports and communications protocols. The application capabilities can include man-in-the-middle detection and prevention techniques 340. A “man-in-the-middle” cybersecurity threat includes interception of communications between a user or endpoint device and an entity with which the user or endpoint device is trying to communicate. The communications interception attempts to extract personal or identifying information from the communications for fraudulent purposes. The application capabilities can include denial-of-service (DOS) and distributed denial-of-service (DDOS) 342 detection techniques. Denial-of-service attacks attempt to render a website, computer, processor, and so on unreachable or unusable by overwhelming it with requests. The application capabilities can include ransomware 344 detection techniques. Ransomware attacks encrypt a victim's data. The encrypted data is only decrypted, if at all, after payment of a ransom.

The cybersecurity threat management and response engine 310 can include an artificial intelligence (AI) user interface. In embodiments, the AI user interface can include a natural language processing (NLP) user interface. The AI user interface can input and output text and/or voice data using human-like language based on the NLP user interface. The AI user interface can be used by security operations center (SOC) personnel to review threat indication amalgamations 350 generated by the machine learning engine 354 included in the SOAR platform. In embodiments, threat protection application misconfigurations can be identified by the machine learning engine 354 included in the SOAR platform and reported to SOC personnel. The SOC staff can use the AI user interface to review the machine learning analysis and suggested remediation steps 352. The AI user interface can also accept input and transmit output to the cybersecurity threat protection applications 320. The SOC staff can make changes to the configurations of cybersecurity threat protection applications based on the application misconfiguration remediation steps. In some embodiments, the network can include an embedded universal data layer comprising two or more cybersecurity threat protection application mappings. The first mapping of the two or more cybersecurity threat application mappings includes a transformation of outputs of each of the plurality of cybersecurity threat applications. The second mapping of the two or more cybersecurity threat application mappings includes a transformation of inputs of each of the plurality of cybersecurity threat applications. The universal data layer (UDL) can be used to “standardize” data provided to or generated by the cybersecurity threat protection applications. The applications can use different but similar terms to describe or label a threat, an action, a result, and so on. In a usage example, a security threat event such as detection of a virus or trojan can cause one application to generate a signal such as “security threat detected”, while a second application can generate a signal such as “virus detected”. Since the different labels are used by the different applications to indicate a substantially similar threat event, the two labels can be standardized. For example, “security threat detected” and “virus detected” can be standardized to “integrity threat” or similar. In embodiments, the SOAR platform can manage cybersecurity for a data network, based on data collected through the first UDL mapping and data transmitted through the second UDL mapping.

The cybersecurity threat management and response engine 310 can include a machine learning engine 354. The machine learning engine 354 can accumulate and analyze the cybersecurity network alerts, warnings, flags, etc. that are generated by the cybersecurity threat protection applications 320. The generating of inferences of cybersecurity threat protection misconfigurations is performed by the machine learning engine, which can be embedded in the SOAR platform and trained by the data gathered by one or more instantiations of the SOAR platform. The machine learning engine also generates mitigation management steps 360 that can be enabled, modified, or bypassed by SOC personnel.

The block diagram 300 can include one or more mitigation management responses 360 generated by the integrated cybersecurity threat management and response engine 310. The generated responses can be provided to a cybersecurity mitigation management entity. A cybersecurity mitigation management entity can include a human-based entity, a machine-based entity, or a combination of human-based and machine-based entities. In embodiments, the cybersecurity mitigation management entity can be a SOC professional. The cybersecurity professional can be an employee of an organization, a consultant to the organization, and so on. In other embodiments, the cybersecurity threat management entity can be a security orchestration, automation, and response (SOAR) application. The SOAR application (or SOAR platform) can handle threat detection, response generation, case tracking, and so on. The system block diagram can include a log concentrator 370. The log concentrator can sort a plurality of log files, can integrate the log files, and so on. The concentrator can extract key information from the log files. The concentrator can compress log file data.

In embodiments, cybersecurity threat events can generate multiple inputs from the plurality of threat protection applications 320 with multiple application capabilities 330. The inputs from the applications can be fed into a log concentrator 370 that can normalize the inputs, place them in time sequence, and forward them to the integrated cybersecurity threat management and response engine 310. The threat management and response engine can use the application inputs to track ongoing mitigation responses based on the cybersecurity threat protection application workflows and statuses of various components and applications involved in a cybersecurity threat event and can compare timings and other parameters of the application responses. The application inputs can also be recorded by the machine learning engine to update its database as new events and mitigation steps are employed by the mitigation management threat management and mitigation engine, and human cybersecurity professionals to provide mitigation management 360, which can be implemented as part of a SOAR platform.

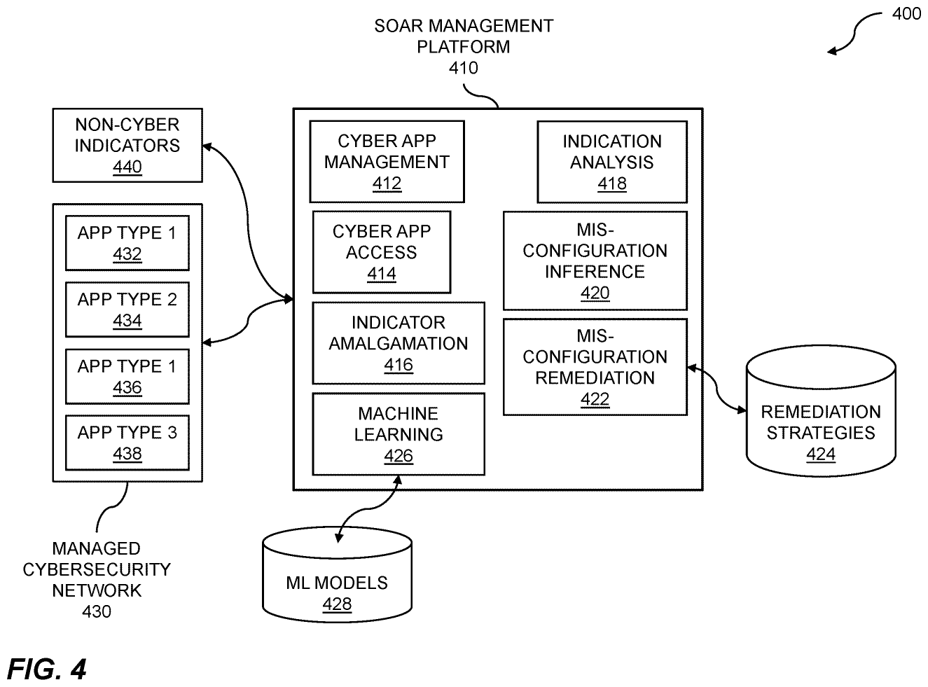

FIG. 4 illustrates a system block diagram 400 for automated cybersecurity misconfiguration detection. The diagram 400 includes a security orchestration, automation, and response (SOAR) platform 410. The SOAR platform 410 can access and manage one or more cybersecurity threat protection applications that are deployed across a managed cybersecurity network 430. The SOAR platform can enable data collection from a wide range of application types, 432, 434, 436, 438 such as endpoint monitoring, anti-phishing, antivirus, DOS/DDOS, and so on. The data sources can include data uploaded by cybersecurity experts as well as non-cybersecurity indicators 440, such as network operating applications, regulatory and audit sources, policy statements, and so on. The SOAR platform can be used to manage threat protection processes, anti-threat technologies, and human expertise. The SOAR platform can centralize management of IT assets such as networks, processors, data storage elements, etc. on a network-connected computer platform. The SOAR platform can provide threat indicators and can also provide contexts for the indicators. The SOAR platform can further automate responses to threats, adapt the responses using machine learning, and so on. The SOAR platform can infer cybersecurity threat protection application misconfigurations 420 based on indication analysis 418 of cybersecurity application and non-cybersecurity application flags, warnings, and so on. The SOAR platform can use a library of cybersecurity remediation strategies 424 to generate misconfiguration remediation steps 422.

The diagram 400 can include an artificial intelligence (AI) user interface. The AI user interface comprises a natural language processing AI user interface. In embodiments, the natural language AI user interface can be accessed by an application program interface (API) in the SOAR platform 410. An application program interface (API) is a set of programs and rules that allow different applications to exchange information. It acts as an intermediate layer that processes data between systems, allowing application data and functionality to extend to third-party developers as well as to internal departments within the same network. In embodiments, one or more API programs can be used to access cybersecurity applications 414 and to manage 412 the cybersecurity applications included in the managed cybersecurity network 430. The API can be used to send requests for data and commands to the cybersecurity threat protection applications. The natural language AI user interface can be accessed using text and/or voice. The natural language AI user interface can be engaged by cybersecurity operations staff. The security operations center (SOC) staff can use the AI user interface to view indication analyses 418 generated by the machine learning engine 426 included in the SOAR platform 410. The AI user interface can also be used to view misconfiguration inferences 420 and misconfiguration remediation steps 422 generated by the machine learning models 428. The AI user interface can be used by the SOC staff to implement, modify, or bypass misconfiguration remediation steps 422 generated by the machine learning models 428.

The diagram 400 includes one or more machine learning models 428. The machine learning models (ML) 428 can be embedded in the SOAR platform 410, wherein the ML is trained by data gathered by one or more instantiations of the SOAR platform. A machine learning (ML) model 428 can be built using data from the cybersecurity threat protection applications accessed 414 through one or more cybersecurity application APIs. In embodiments, the machine learning model 428 can be used by the machine learning engine 426 to analyze cybersecurity threat protection application threat indicators coming from multiple cybersecurity application types 432, 434, 436, 438. The analysis 418 can include indicators from non-cybersecurity applications. The cybersecurity data can be accessed 414 using one or more application APIs. The SOAR platform 410 can amalgamate the various threat indicators 416 and present them to the machine learning engine 426. The machine learning engine can use the machine learning models to analyze the amalgamated threat indicators to search for cybersecurity application misconfigurations. When a group of amalgamated threat indicators does not match previous patterns of threat indicators learned by the machine learning models 428, the machine learning model can infer 420 a misconfiguration of one or more cybersecurity applications. The machine learning model can use a library of remediation strategies 424 to generate one or more misconfiguration remediation steps 422. In some embodiments, the misconfiguration remediation steps 422 can be viewed by SOC personnel and implemented, modified, or bypassed. In other embodiments, the machine learning engine 426 can use one or more machine learning models 428 to reconfigure one or more cybersecurity threat protection applications based on the misconfiguration remediation steps 422.

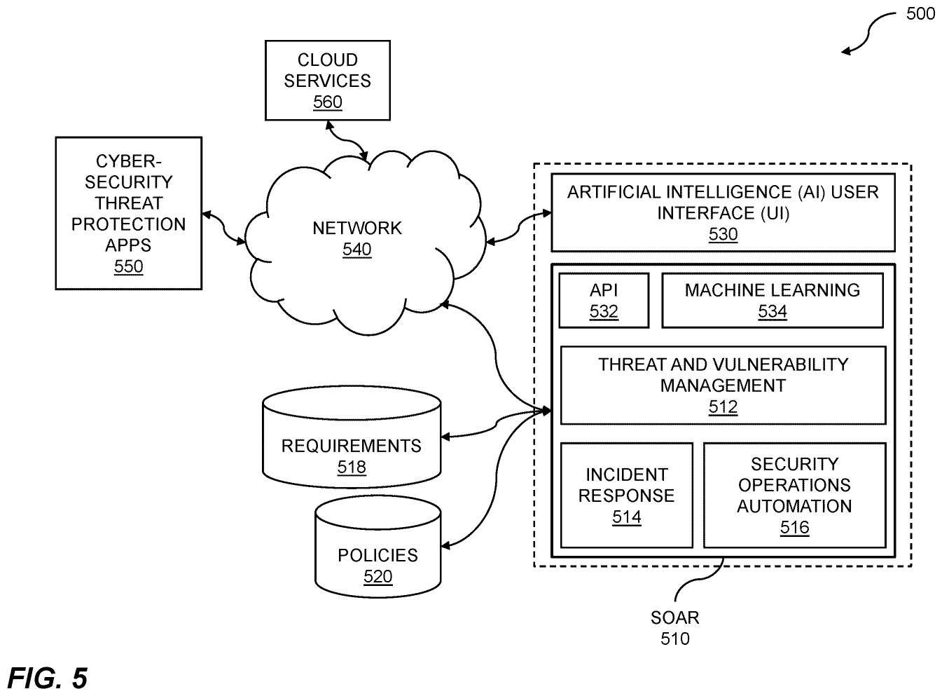

FIG. 5 shows a network-connected security orchestration, automation, and response (SOAR) system. Cybersecurity threats can occur as often as every few seconds. These threats target individual users, businesses, universities, hospitals, government agencies, and so on. The cybersecurity threats constitute extreme menaces, and indeed existential crises, to the enterprises. Cybersecurity threat management includes identifying that a threat is underway, what IT infrastructure and data are under attack, the type of threat, etc. The cybersecurity threat management ideally then proceeds to block and remove the threat, isolate affected infrastructure, perform eradication or remediation, and the like. Cybersecurity management is enabled by cybersecurity mitigation and completion confirmation management along with threat and vulnerability management. A plurality of network-connected cybersecurity threat protection applications is accessed. A plurality of inputs is received from the cybersecurity threat protection applications, wherein the plurality of inputs is initiated by one or more cybersecurity events. A network-connected computer platform is used to analyze the plurality of inputs and the metadata associated with the plurality of inputs from the cybersecurity threat protection applications. The inputs are analyzed by the threat and vulnerability management element. A cybersecurity threat mitigation workflow is generated based on the analysis. A mitigation management system oversees deployment of the mitigation workflow, tracks progress, and compares mitigation results and timing to a library of mitigation success metrics. The mitigation and completion management system updates the library of success metrics and reports on the threat mitigation responses to cybersecurity management. A machine learning model in the SOAR platform can analyze actions and responses generated by mitigation workflows and update the workflows in order to improve performance, based on the mitigation success metrics.

A network-connected security orchestration, automation, and response (SOAR) system is illustrated 500. The heart of a SOAR system can comprise a SOAR application or platform 510, where the SOAR platform can be based on one or more cybersecurity threat protection applications, tools, techniques, and so on. The SOAR platform can enable data collection from a wide range of data sources such as threat data sources. The threat data sources can include data uploaded by cybersecurity experts, data produced by cybersecurity threat protection applications, and so on. The SOAR platform can be used to manage threat protection processes, anti-threat technologies, and human expertise. The SOAR platform can centralize management of IT assets such as networks, processors, data storage elements, etc. on a network-connected computer platform. The SOAR platform can provide threat alerts and can also provide contexts for the alerts. The SOAR platform can further automate responses to threats, adapt the responses using machine learning, and so on. The SOAR platform can use a library of cybersecurity mitigation success metrics to compare timing and effectiveness of mitigation steps to previous events and successful mitigation processes.

The illustration 500 can include one or more components associated with cybersecurity threat management. The SOAR platform can include a threat and vulnerability management component 512. The threat and vulnerability management component can configure and control IT infrastructure elements such as routers, switches, processors, storage area networks (SANs), and so on. The SOAR platform can include an incident response component 514. The incident response component can provide alerts, can trigger one or more actionable responses, and the like. In embodiments, the actionable response can enable scalability of a connected SOAR system. The SOAR system can be scaled up to address many threats, to reduce threat response time, etc. In embodiments, the actionable response can include a recommendation for cybersecurity operations staff. The recommendation can include a direction for a threat response policy, a source for further information about the threat, a plan for taking remedial steps, a suggestion for automating recidivistic actions, etc. In further embodiments, the actionable response can include an autonomic network reconfiguration. An autonomic network reconfiguration can include isolating IT elements, restricting IT elements, and the like. In embodiments, the actionable response can include an autonomic cybersecurity threat protection application reconfiguration. The threat protection application reconfiguration can include isolating, reinstalling, reconfiguring, or rebooting an application. The threat protection application reconfiguration can include synchronizing operation of two or more threat protection applications.

The illustration 500 can include security operations automation 516. Security operations management can include automatically securing IT infrastructure elements such as switches, routers, processors, storage elements, etc., where the securing can be based on a procedure, a policy, and so on. The security operations automation can include updating IT element software and firmware, installing and configuring security software such as antivirus software, and the like. Cybersecurity threat application inputs can include alerts, text or SMS messages, email, a rendering on a graphical display, and so on. The analysis can be based on metadata associated with the plurality of inputs from the cybersecurity threat protection applications. The metadata can include a variety of status and other information such as a time and a frequency of cybersecurity threat protection application inputs, one or more techniques used to receive the application inputs, who or what tool provided the application inputs, etc. The mitigation response can include a workflow that can be developed to address, rectify, remediate, prevent, etc. the cybersecurity threat. The cybersecurity threat response can address various types of events such as a zero-day event.

The illustration 500 can include an artificial intelligence (AI) user interface (UI) 530. The AI user interface comprises a natural language processing (NLP) AI user interface. NLP uses rule-based and statistical models, as well as machine learning and deep learning techniques, to process and analyze large amounts of natural language data. In embodiments, the natural language AI user interface is embedded in the SOAR platform, wherein the natural language AI user interface is accessed by an application program interface (API) 532 in the SOAR platform. An application program interface (API) 532 is a set of programs and rules that allow different applications to exchange information. It acts as an intermediate layer that processes data between systems, allowing application data and functionality to extend to third-party developers as well as to internal departments within the same network. In embodiments, one or more APIs can be used to accept data from the one or more cybersecurity threat protection applications into the natural language AI user interface. The API can also be used to send requests for data and commands to the cybersecurity threat protection applications. The natural language AI user interface can be accessed using text and/or voice. The natural language AI user interface can be engaged by a cybersecurity network representative.

The illustration 500 includes one or more cybersecurity network compliance requirements 518. In embodiments, the compliance requirements 518 are based on one or more compliance standards, regulatory requirements, company policy documents, and company incident response documents. The compliance requirements can be based on company industry segment standards. Governments, businesses, industries, and regulatory bodies work to set and maintain cybersecurity standards for their members. Regulatory bodies routinely publish and update policies and standards as cybersecurity threats increase and evolve. Small businesses and private individuals can subscribe to cybersecurity services and purchase hardware and software that can help to mitigate the threats to their data, applications, and hardware, as well as their finances. Interpreting the network compliance requirements can be done by inputting text from regulatory and compliance documentation, internal company policy documents, audit findings, incident reports, and so on. The input can be done verbally or in written word through the AI user interface 530. Input from the cybersecurity threat protection applications can use the API 532 into the natural language AI user interface as well. The input from all of these sources into the database of the AI user interface can enable the SOAR platform to converse programmatically with the cybersecurity threat protection applications, interpret their data, respond to their input, and manage the tasks undertaken by the applications as they react to cybersecurity events. In embodiments, translating the network compliance requirements 518 into workflow policies 520 and processes that the threat protection applications can implement is performed using machine learning (ML) 534. The ML is embedded in the SOAR platform 510, wherein the ML is trained by data gathered by one or more instantiations of the SOAR platform. The ML can be accessed through an application program interface (API) in the SOAR platform. A machine learning (ML) model can be built using compliance and regulatory data from the natural language AI user interface and data from the cybersecurity threat protection applications input through one or more API.

The SOAR platform 510 can use a network 540 to access a plurality of cybersecurity threat protection applications 550. The network can include a wired network, a wireless network, a hybrid wireless/wireless network, and so on. The network can be based on wired networking standards such as Ethernet™ (IEEE 802.3), wireless networking standards such as Wi-Fi™ (IEEE 802.11), and so on. The cybersecurity threat protection applications can provide capabilities such as endpoint protection, anti-phishing, antivirus, firewalls, and so on. The cybersecurity threat protection applications can further detect and protect against man-in-the middle ruses, denial-of-service (DOS) and distributed denial-of-service (DDOS) attacks, ransomware, and the like. In embodiments, the background synchronization service can communicate to the plurality of network-connected cybersecurity threat protection applications using cloud services 560. The cloud services can provide access and can also provide IT services such as software as a service (SaaS), platform as a service (PaaS), infrastructure as a service (IaaS), and so on.

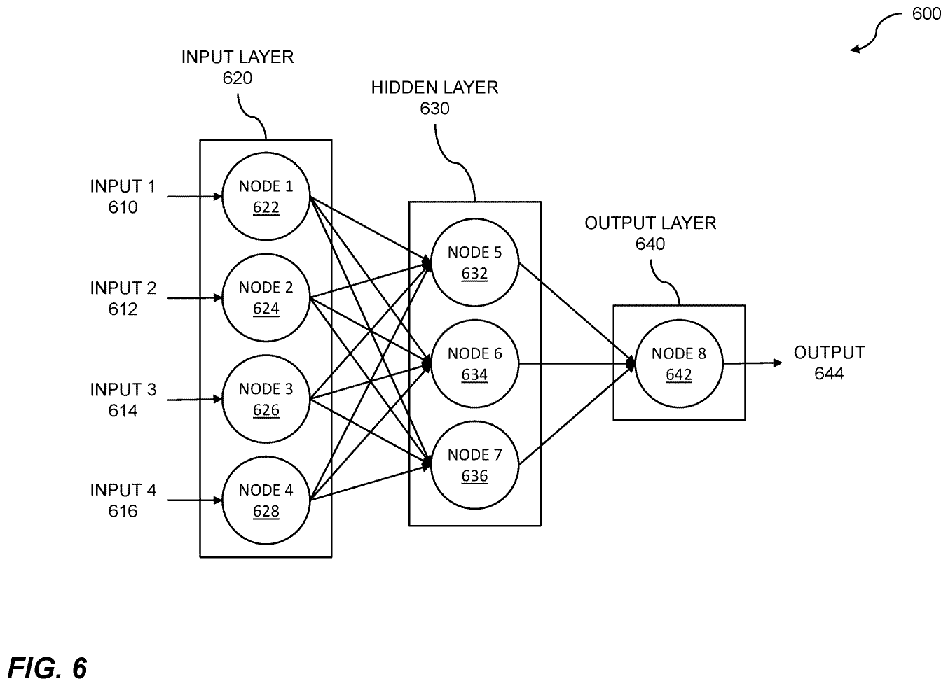

FIG. 6 shows an example neural network 600 for machine learning. The neural network for machine learning can be based on a variety of neural network types such as a convolutional neural network (CNN), a deep neural network (DNN), a recurrent neural network (RNN), and so on. The neural network for machine learning comprises a plurality of layers, where the layers can include one or more of an input layer, an output layer, a convolutional layer, a bottleneck layer, an activation layer, and the like. The bottleneck layer, if present within the neural network, can be used for neural network training. The trained neural network can be applied to cybersecurity operations tasks such as cybersecurity operations case triage groupings. A neural network for machine learning can apply classifiers. The classifiers can be learned based on one or more inputs from a plurality of network-connected cybersecurity threat protection applications. A plurality of network-connected cybersecurity threat protection applications is accessed. A plurality of inputs is received from the cybersecurity threat protection applications, wherein the plurality of inputs is initiated by one or more cybersecurity events. A computer platform is used to analyze metadata associated with the plurality of inputs from the cybersecurity threat protection applications. The inputs are triaged into groupings, based on the metadata. A cybersecurity threat response is generated, based on the groupings.

The example 600 shows a neural network for machine learning. The neural network includes one or more layers such as input layers, hidden layers, and output layers. Layers, such as convolutional layers, activation layers, bottleneck layers, etc., that perform operations associated with applications such as machine learning can also be included within the example neural network. Data can be provided to the neural network though inputs such as input 1 610, input 2 612, input 3 614, and input 4 616. While four inputs are shown, other numbers of inputs can also be applied to the neural network. The data can include training data, production data, etc. The data is provided to an input layer 620 of the neural network. The input layer comprises one or more nodes such as node 1 622, node 2 624, node 3 626, and node 4 628. While four nodes are shown within the input layer, other numbers of nodes can be included. One or more weights (explained below) can also be provided to each node within the input layer. The outputs of the nodes associated with the input layer can be coupled to inputs of nodes associated with a hidden layer such as hidden layer 630. The hidden layer can comprise one or more nodes such as node 5 632, node 6 634, and node 7 636. While three nodes are shown, other numbers of nodes can be included in the hidden layer. In the example neural network, each output of the nodes associated with the input layer is coupled to each input of the nodes associated with the hidden layer. The coupling of each node output to each node input accomplishes a fully connected (FC) layer within the neural network.

The example neural network can include one or more hidden layers. The hidden layers can include substantially similar or substantially dissimilar numbers of nodes. The hidden layers can be fully connected layers as just described, convolutional layers where a subset of outputs is connected to a subset of inputs, bottleneck layers, activation layers, etc. The example neural network includes an output layer 640. The output layer can include one or more nodes such as node 8 642. While one node is shown within the output layer, the output layer can include more than one node. The output layer produces an output 644. The output can include a value, a probability, and so on.

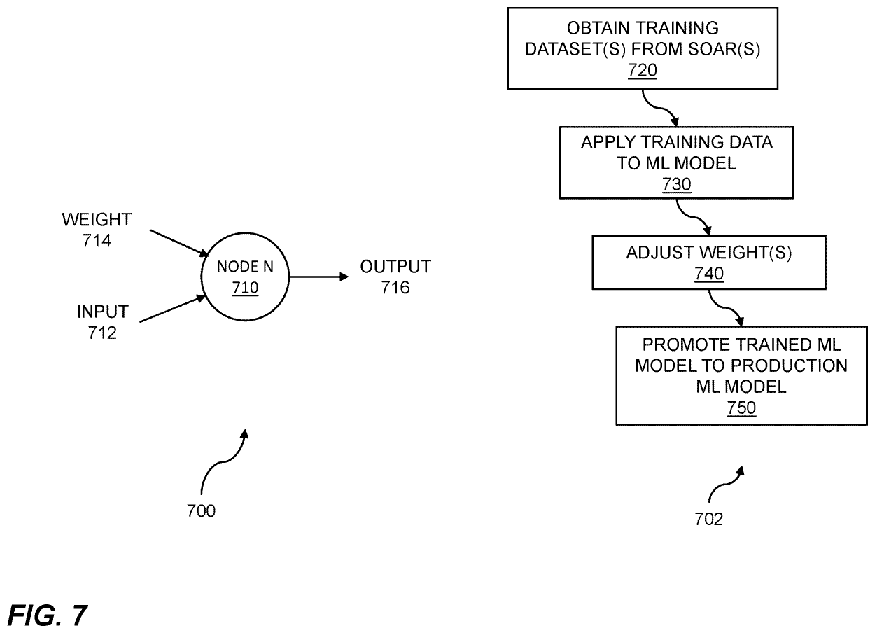

FIG. 7 shows an example 700 of training a neural network for machine learning. As discussed in FIG. 6, a neural network comprises layers of nodes or neurons such as artificial neurons 622, 632, and 642, among others. The artificial neuron can be configured to process input data in order to produce output data. An example node N 710 is shown. A neuron can be coupled to one or more signals or inputs such as input 712, and one or more weights such as weight 714. The node multiplies each input by its corresponding weight and maintains a running sum of the resulting products. The output of the node, such as output 716, can be calculated by applying a function such as a transfer function to the sum of products of the inputs and weights. The transfer function can include various types of functions such as a unit step or threshold function, a sigmoid, a Gaussian function, a piece-wise linear function, and so on.

Each neuron within a neural network can be trained. The training can be based on using a dataset that includes known data. The training can be further based on comparing results of data processing by the neural network with expected results associated with the known data. The expected results include results of neural network processing of the dataset of known data. One or more weights associated with each node are adjusted until the neural network can form an inference that produces the expected result. In a usage example, a dataset of images of dogs or cats can be used to train a neural network to identify dogs or cats within images not included in the training data set. A flow for neural network training is shown. The neural network training can include training a neural network for machine learning applications. The flow 702 includes obtaining 720 a training dataset. The training dataset can include cybersecurity operations center caseload histories, resolutions to cybersecurity threats, and so on. The training dataset can include threat response resolution metrics. The training dataset can further include one or more objective ratings, where the objective ratings can be used to update the threat response resolution metrics. Further, a subjective rating can include a management-supplied rating, a peer-supplied rating, a machine-learning-supplied rating, etc.

The flow 702 includes applying 730 the training data to a neural network. The training data is provided to the inputs of the neural network and the neural network proceeds to process the test data. The flow 702 includes adjusting one or more weights 740 associated with the nodes of the neural network. The adjusting the weights can enable enhanced convergence by the neural network to an expected result. The enhanced convergence can reduce neural network processing time, improve inference accuracy, etc. The adjusting the weights can include an iterative process. The adjusting weights associated with the nodes within the neural network can become more accurate as further training data is provided. The flow 702 includes promoting the trained neural network 750 to a production neural network. The production neural network can be used to process data such as a security operations center (SOC) caseload history. The production neural network can continue to adapt or learn based on processing further data. The learning can include further adjustment to one or more weights associated with nodes within the neural network. In embodiments, the accessing, the analyzing, the augmenting, the receiving, and the assigning, all of which are discussed previously, can be converted to machine learning training data. The machine learning training data that was converted can be used to further train or adjust the machine learning neural network.

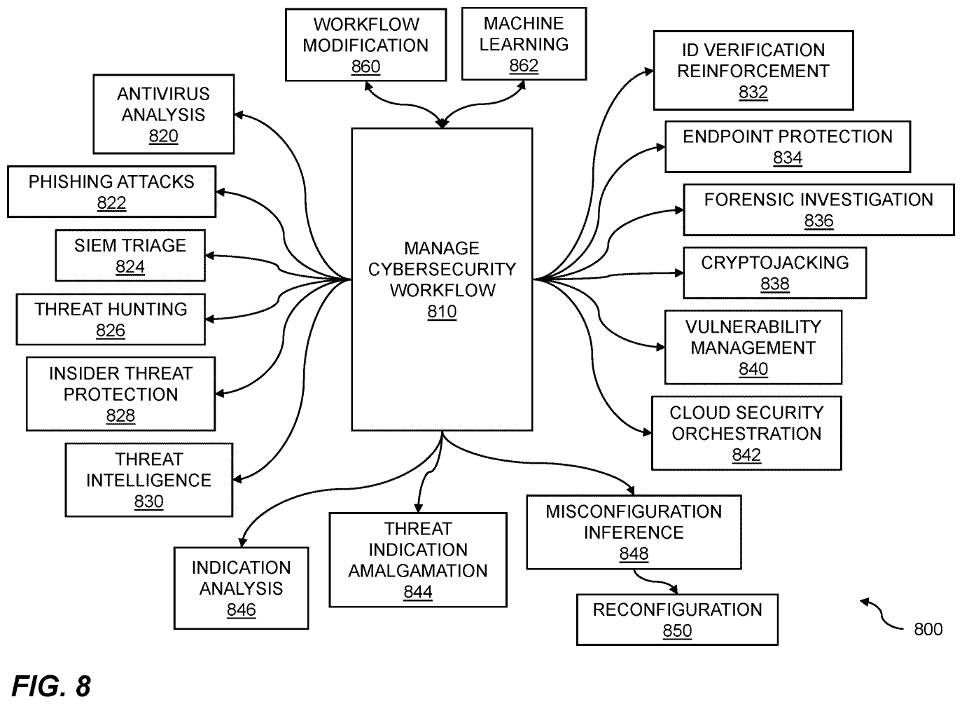

FIG. 8 is an infographic for cybersecurity workflow management. The infographic 800 includes cybersecurity management 810. Cybersecurity management can include prioritizing a variety of IT techniques for identifying threat risks, correcting identified risks, counteracting active threats, and so on. Cybersecurity management can be based on accessing a range of applications (discussed below) which can include antivirus software, access control, data encryption, network channel encryption, and the like. In embodiments, cybersecurity includes managing the plurality of threat protection applications for a data network. The techniques that can be used for cybersecurity management can be based on one or more workflows. The workflows, which can include cybersecurity tasks and commands, can automate various tasks associated with cybersecurity management. In embodiments, the managing cybersecurity can include graphical control of the plurality of cybersecurity threat protection applications. The graphical control can enable dragging and dropping of tasks, commands, and so on into a workflow. In other embodiments, the automation workflows can support dynamic swapping of cybersecurity threat protection applications. The workflows can support swapping-in or swapping-out one or more threat protection applications. The swapping-in and the swapping-out are enabled by a universal data layer (UDL). The UDL enables applications to be swapped without having to edit a workflow or create a new workflow to address the swapped-in application.

The infographic 800 can include workflow modification 860. In embodiments, actions and responses generated by cybersecurity threat management applications, security operations staff, users, third-party AI systems, the SOAR platform, and so on can be captured as cybersecurity incidents occur. The cybersecurity workflows, actions, responses, and timings can be analyzed by machine learning 862, and the results can be compared to established requirements. The analysis can include responses generated by threat protection applications, separate AI security systems, or security operations staff. The analysis can include remedial step actions suggested to security operations staff by the SOAR platform or cybersecurity threat protection applications. The analysis can include recidivistic security operations responses generated by threat protection applications or operations staff members. The analysis can include repeated cybersecurity incidents logged by the SOAR platform or the security operations center. The analysis can include cybersecurity threat protection indications and indication abnormalities. The analysis can include cybersecurity application misconfigurations. The machine learning analysis can use multiple instantiations of the SOAR platform to generate and test changes to the order of workflow steps, automation of recidivistic responses, changes in schedule or timing of actions, changes in configurations, and so on. The machine learning 862 can generate updates to the workflows and application configurations automatically in real time, including remedial steps or the reordering of remedial steps.

An AI user interface included in the SOAR platform can be used to assimilate cybersecurity network compliance requirements. The compliance requirements are based on one or more compliance standards, regulatory requirements, company policy documents, and company incident response documents. The infographic 800 includes translating the cybersecurity network compliance requirements into one or more cybersecurity application policies. The cybersecurity application policies provide cybersecurity network conformity with the compliance requirements. Input from the various compliance, regulatory, and company policy statements regarding cybersecurity standards and responses into a natural language AI user interface allows the SOAR platform to interpret the requirements for the threat protection applications installed on the managed cybersecurity network. Input from the cybersecurity threat protection applications allows the SOAR platform to interact with the applications. In embodiments, translating the network compliance requirements into policies and workflows that the threat protection applications can implement is performed using machine learning (ML) 862. The ML can be embedded in the SOAR platform, wherein the ML is trained by data gathered by one or more instantiations of the SOAR platform. The ML can be resident outside of the SOAR (for example, a third-party or hosted ML platform) accessed through an application program interface (API) in the SOAR platform. A machine learning (ML) model can be built using compliance and regulatory data from the natural language AI user interface and data from the cybersecurity threat protection applications input through one or more APIs. In embodiments, the result is to generate a set of application policies and workflows for each of the cybersecurity threat protection applications that direct the applications to respond to cybersecurity events in a manner that is consistent with the internal and external regulatory and compliance requirements for the network. The cybersecurity application policies and workflows can include information on how to respond to specific types of threats, how often to report operational status, how often and when to install updates, whom to notify during priority events, how to notify, and so on. The cybersecurity application policies and workflows can include details on which processes are to be handled by the SOAR platform, so that only condition and status data is sent forward to the SOAR platform, and which processes are to be handled by the threat protection applications directly, with status data to follow. The policies and workflows can include settings on how a threat protection application is to proceed in the event the SOAR platform is unavailable, and so on.

The infographic 800 includes antivirus analysis 820. Antivirus analysis can include virus detection, Trojan horse program detection, and so on. The analysis can include determining a source or vector of a virus, the actions taken by the virus, how to counter actions taken by the virus, to whom the virus might be in communication, etc. The antivirus analysis can be used to determine changes or updates to the virus, and how to better detect the virus before it can be deployed. The infographic 800 can include analysis of phishing attacks 822. Phishing is a form of attack that attempts to fraudulently obtain personal, sensitive, or private data and information. The data or information that is sought by a phishing attack can include personal information such as name, address, date of birth, telephone number, email address, and so on. The information can further include government-related information such as social security numbers, tax records, military service information, etc. The information can also include usernames and passwords to sensitive websites such as banks, brokerages, hospitals and health care providers, and the like. A phishing attack can purport to be from an entity known to a user by presenting the user with a legitimate looking webpage. However, links on the fraudulent page do not take the user to the legitimate site, but rather to a site designed to steal the victim's data.

The infographic 800 includes security information and event management (SIEM) triage 824. SIEM, which combines the management of security information and security events, can provide analysis of security alerts, alarms, warnings, etc. in real time. The alerts that are analyzed can be generated by one or more of the plurality of cybersecurity threat protection applications, by network security hardware, and so on. The triage can be used to determine the severity of an alert, the scale or extent of the alert, the urgency of the alert, and the like. The infographic 800 includes threat hunting 826. Threat hunting can include techniques used to locate cybersecurity threats within a network, where the threats can elude detection using more common threat detection techniques. Threat hunting can include iteratively searching network-connected devices throughout a data network. Threat hunting can be used in addition to common cybersecurity techniques including firewalls for port blocking, intrusion detection, etc. The infographic 800 includes insider threat protection 828. Insider threats are among the most difficult threats to counter because they are perpetrated by people who have knowledge of the security techniques implemented by an organization. An insider threat attack can include physical damage to computing, data, and network systems; data breaches; and the like. Insider threats can result from overly permissive access to sensitive areas or data, lax firewall policies, etc. An insider attack can include moving sensitive data to another device within the organization-a lateral transfer.

The infographic 800 includes threat intelligence 830. Threat intelligence can include information associated with cybersecurity threats, used by an organization. The threat intelligence information can be associated with past security threats, current security threats, and threats likely to arise in the future. The information can be used by the organization to identify cybersecurity threats, to prevent the threats, and to prepare for inevitable threats that are likely to emerge in the future. The infographic 800 includes identity verification reinforcement 832. Identity verification can include techniques to verify that a person who has access to computing systems, data systems, networks, and so on, that are associated with an enterprise, is in fact a real person. Identity verification can be based on physical documents such as a government issued identification documents. The infographic 800 can include endpoint protection 834. In a typical enterprise computing environment, individuals may try to use personal electronic devices to access the enterprise network. Such devices can include laptop computers, tablets, PDAs, smartphones, and the like. Such devices can pose a serious threat to an enterprise network because of operating systems which may not be updated, questionable applications which may be installed on the devices, etc. Endpoint protection can require that any device, including personal electronic devices, meets certain standards prior to connection to the enterprise network. The standards can include approved devices, operating systems, applications, antivirus applications, virtual private network apps, etc.

The infographic 800 includes forensic investigation 836. Digital forensic investigation can include data recovery, data maintenance, and investigation of data and information that can be found on various digital devices. Digital forensic techniques can be applied for investigation of a variety of digital malfeasances including cybercrime. Forensic investigation techniques can be used to determine, track, and locate perpetrators of cybercrime. The infographic 800 includes the detection of cryptojacking 838. Cryptojacking can include hijacking of computers, servers, personal electronic devices, and so on for the purposes of mining cryptocurrency. The infographic 800 includes vulnerability management 840. Vulnerability management seeks to reduce risks to computing systems, data systems, networks, and so on by identifying, evaluating, correcting, and communicating vulnerabilities associated with the computing systems and the applications that are executed on the computing systems. The infographic 800 includes cloud security orchestration 842. Many individuals, and organizations such as businesses, hospitals, universities, and government agencies, use cloud services for processing, data storage, and other IT services. Cloud orchestration can manage relationships, interactions, and communications among computational workloads. The computational workloads can be associated with public cloud infrastructure and private cloud infrastructure. Cloud security orchestration can include imposing permissions and access oversight, and policy enforcement.

The infographic 800 includes threat indication amalgamation 844. Threat indications generated by the various applications such as antivirus, anti-fishing, endpoint protection, and so on, can be gathered by the SOAR platform and amalgamated for use by a machine learning model. The machine learning model can take in the amalgamated threat indication data and analyze it. The infographic 800 includes cybersecurity threat protection indication analysis 846. The machine learning model can search for patterns of threat indications to determine how to mitigate the one or more threats. If the amalgamated threat indications do not match a pattern previously learned by the ML model, misconfiguration inferences 848 of one or more threat protection applications can be made. Reconfiguration steps 850 can be generated by the machine learning model and made available for review by SOC personnel. The SOC staff can choose to implement, modify, or bypass one or more reconfiguration steps 850. The SOAR platform can coordinate actions taken by cybersecurity threat protection applications and SOC personnel as they are implemented. The timing and effectiveness of the mitigation steps can be tracked and compared to a library of cybersecurity mitigation success metrics. The results can be reported to cybersecurity managers and machine learning models to improve responses and identify possible weak points in network security.

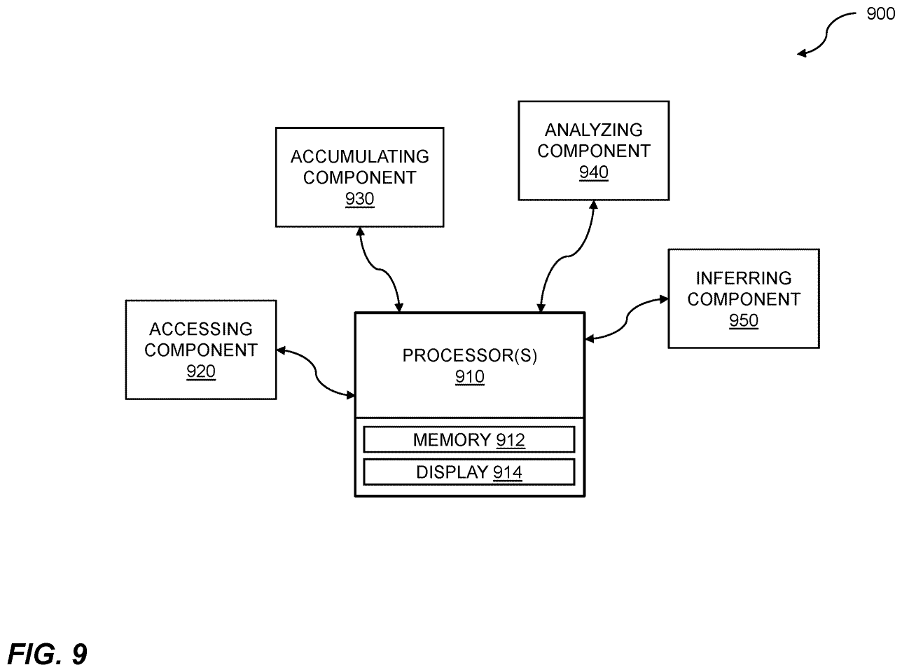

FIG. 9 is a system diagram 900 for automated cybersecurity misconfiguration detection. The system 900 includes one or more processors 910 coupled to a memory 912 which stores instructions. The system 900 includes a display 914 coupled to the one or more processors 910 for displaying data, database information, programming details, intermediate steps, instructions, and so on. In embodiments, one or more processors 910 are coupled to the memory 912 where the one or more processors, when executing the instructions which are stored, are configured to: access a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform; accumulate one or more cybersecurity threat protection indications from the plurality of cybersecurity threat protection applications; analyze the one or more cybersecurity threat protection indications that were accumulated, wherein the analyzing determines an indication abnormality; and infer a cybersecurity threat protection application misconfiguration, based on the analyzing.

The system 900 includes an accessing component 920. The accessing component 920 includes functions and instructions for accessing a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform. In embodiments, the threat protection applications can monitor, protect, and defend computer systems, data systems, data networks, handheld electronic devices, and so on against various types of malicious attacks. The malicious attacks can include malware attacks, hacking attacks, denial of service attacks (DoS), distributed denial of service attacks (DDoS), man-in-the-middle attacks, ransomware attacks, and so on. The applications can include antivirus and anti-phishing applications, tools for threat hunting and threat intelligence, identity verification, endpoint protection, and so on. The applications can further include firewalls and other blocking technology.

The system 900 includes an accumulating component 930. The accumulating component 930 includes functions and instructions for accumulating one or more cybersecurity threat protection indications from the plurality of cybersecurity threat protection applications. In embodiments, the indications can include alarms, alerts, notifications, status changes and updates, warnings, etc. The indications can be in reference to virus detection, Trojan horse detection, insider threat detection, cryptojacking detection, intrusion detection, and so on. In embodiments, the accumulating indications from the plurality of cybersecurity threat protection applications is performed by the SOAR platform. The SOAR platform can accumulate the threat indications, sort and categorize them, send acknowledgements to the relevant threat protection applications, and organize the indications data input for analysis.

The system 900 includes an analyzing component 940. The analyzing component 940 includes functions and instructions for analyzing the one or more cybersecurity threat protection indications that were accumulated, wherein the analyzing determines an indication abnormality. In embodiments, the analyzing and/or inferring are performed using machine learning (ML) embedded in the SOAR platform. Multiple instantiations of the SOAR platform can be generated to test and refine actions and responses to various cybersecurity threats, application update requirements, actions taken by users and/or operations security staff members, and so on. As cybersecurity events occur, either within the SOAR-managed cybersecurity network or on similar networks across the globe, incident reports in various forms are published by threat protection application vendors, regulatory agencies, auditors, watchdog agencies, internal audit and compliance departments, IT departments, and so on. All of this input can be used to analyze and refine cybersecurity workflows, policies, rules, and application settings.

The system 900 includes an inferring component 950. The inferring component 950 includes functions and instructions for inferring a cybersecurity threat protection application misconfiguration, based on the analyzing. In embodiments, a cybersecurity threat protection application misconfiguration can cause the cybersecurity threat protection indication. The misconfiguration can indicate a cybersecurity threat protection application false positive. The indication abnormality can be based on one or more cybersecurity threat protection indications from a single type of cybersecurity threat protection application. The indication abnormality can be based on two or more cybersecurity threat protection indications from a plurality of cybersecurity threat protection applications.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for cybersecurity management comprising:
accessing a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform;
accumulating one or more cybersecurity threat protection indications from the plurality of cybersecurity threat protection applications;
analyzing the one or more cybersecurity threat protection indications that were accumulated, wherein the analyzing determines an indication abnormality; and
inferring a cybersecurity threat protection application misconfiguration, based on the analyzing.

2. The method of claim 1 wherein the misconfiguration indicates a cybersecurity threat protection application false positive.

3. The method of claim 2 wherein the false positive is determined by non-permitted application scenarios.

4. The method of claim 2 wherein the false positive is determined by security operations center personnel.

5. The method of claim 1 wherein the cybersecurity threat protection application misconfiguration causes the cybersecurity threat protection indication.

6. The method of claim 1 wherein the indication abnormality is based on one or more cybersecurity threat protection indications from a single type of cybersecurity threat protection application.

7. The method of claim 6 wherein the indication abnormality is based on a time-sequenced commonality among two or more cybersecurity threat protection indications.

8. The method of claim 7 wherein the time-sequenced commonality occurs over more than one login of an endpoint application.

9. The method of claim 1 wherein the indication abnormality is based on two or more cybersecurity threat protection indications from a plurality of cybersecurity threat protection applications.

10. The method of claim 9 wherein the indication abnormality is based on a time-sequenced commonality among the plurality of cybersecurity threat protection applications.

11. The method of claim 9 wherein the indication abnormality comprises a positive threat protection indication from one cybersecurity threat protection application and a contemporaneous negative threat protection indication from another cybersecurity threat protection application.

12. The method of claim 1 further comprising providing a remedial action, based on the inferring.

13. The method of claim 12 wherein the remedial action is ingested by the SOAR for automatic reconfiguration.

14. The method of claim 1 wherein the analyzing or the inferring are performed using machine learning (ML).

15. The method of claim 14 wherein the ML is trained by data gathered by one or more instantiations of the SOAR platform.

16. A computer system for cybersecurity management comprising:
a memory which stores instructions;
one or more processors coupled to the memory wherein the one or more processors, when executing the instructions which are stored, are configured to:
access a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform;
accumulate one or more cybersecurity threat protection indications from the plurality of cybersecurity threat protection applications;
analyze the one or more cybersecurity threat protection indications that were accumulated, wherein the analyzing determines an indication abnormality; and
infer a cybersecurity threat protection application misconfiguration, based on the analyzing.

17. The computer system of claim 16 wherein the misconfiguration indicates a cybersecurity threat protection application false positive.

18. The computer system of claim 16 wherein the indication abnormality is based on one or more cybersecurity threat protection indications from a single type of cybersecurity threat protection application.

19. The computer system of claim 16 wherein the indication abnormality is based on two or more cybersecurity threat protection indications from a plurality of cybersecurity threat protection applications.

20. The computer system of claim 16 wherein the analyzing or the inferring are performed using machine learning (ML).
